(19) United States
(12) Patent Application Publication
(10) Pub. No.: US 2009/0272556 A1
(43) Pub. Date: Nov. 5, 2009

(54) ANGLE HEAD AND BEVEL GEAR FOR TOOL

(75) Inventors: Randi Jane Young, Randolph, NJ (US); Nathanael S. Murphy, Hellertown, PA (US)

Correspondence Address: MICHAEL BEST & FRIEDRICH LLP, 100 E WISCONSIN AVENUE, Suite 3300, MILWAUKEE, WI, 53202, US

(73) Assignee: INGERSOLL-RAND COMPANY, Montvale, NJ (US)

(21) Appl. No.: 12/115,161

(22) Filed: May 5, 2008

(51) Int. Cl. F16H 1/12; B23P 15/14

(52) U.S. Cl. 173/216; 74/417; 29/893; 29/428

(57) ABSTRACT

An angle head for use with a power tool includes an angle housing defining first and second non-parallel axes and a pinion shaft supported within the angle housing for rotation about the first axis. The pinion shaft has a first end that includes a plurality of pinion teeth, and a second end adapted to be engaged by a motor of a power tool. The angle head also includes a bevel gear supported in the angle housing for rotation about the second axis. The bevel gear includes an upper shaft, a toothed portion, and an output spindle. The upper shaft, toothed portion, and output spindle are integrally formed as a single, monolithic structure. The toothed portion is between the upper shaft and output spindle. The toothed portion includes a plurality of bevel teeth in meshing engagement with the pinion teeth such that rotation of the pinion shaft about the first axis causes rotation of the bevel gear about the second axis.

### BACKGROUND

The present invention relates to angle heads for power tools.

### SUMMARY

In one embodiment, the invention provides an angle head for use with a power tool that includes an angle housing defining first and second non-parallel axes, and a pinion shaft supported within the angle housing for rotation about the first axis. The pinion shaft has a first end that includes a plurality of pinion teeth, and a second end adapted to be engaged by a motor of a power tool. The angle head also includes a bevel gear supported in the angle housing for rotation about the second axis. The bevel gear includes an upper shaft, a toothed portion, and an output spindle. The upper shaft, toothed portion, and output spindle are integrally formed as a single, monolithic structure. The toothed portion is between the upper shaft and output spindle. The toothed portion includes a plurality of bevel teeth in meshing engagement with the pinion teeth such that rotation of the pinion shaft about the first axis causes rotation of the bevel gear about the second axis.

In another embodiment the invention provides a method of producing an angle head for use with a power tool. The method includes the steps of: (a) providing an angle housing that defines first and second non-parallel axes; (b) supporting a pinion shaft in the angle housing for rotation about the first axis, the pinion shaft having a first end that includes a plurality of pinion teeth, and a second end adapted to be engaged by a motor of a power tool; (c) forging a bevel gear blank having a toothed portion with first and second opposite sides and a plurality of forged bevel teeth, an upper extension extending from the first side, and a lower extension extending from the second side; (d) machining the upper extension to form an upper support shaft and the lower extension to form an output spindle to turn the bevel gear blank into a bevel gear; and (e) supporting the bevel gear within the angle housing for rotation about the second axis, with the forged bevel teeth in meshing engagement with the pinion teeth of the pinion shaft such that rotation of the pinion shaft about the first axis causes rotation of the bevel gear about the second axis.

Other aspects of the invention will become apparent by consideration of the detailed description and accompanying drawings.

### BRIEF DESCRIPTION OF THE DRAWINGS

FIG. 1 is a perspective view of a power tool with an angle head according to an embodiment of the invention.

FIG. 2 is an exploded perspective view of the angle head of FIG. 1.

FIG. 3 is a cross-sectional view of the angle head of FIG. 1 taken along line 3-3.

FIG. 4 is a front view of a bevel gear blank according to an embodiment of the invention.

FIG. 5 is a front view of a bevel gear according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

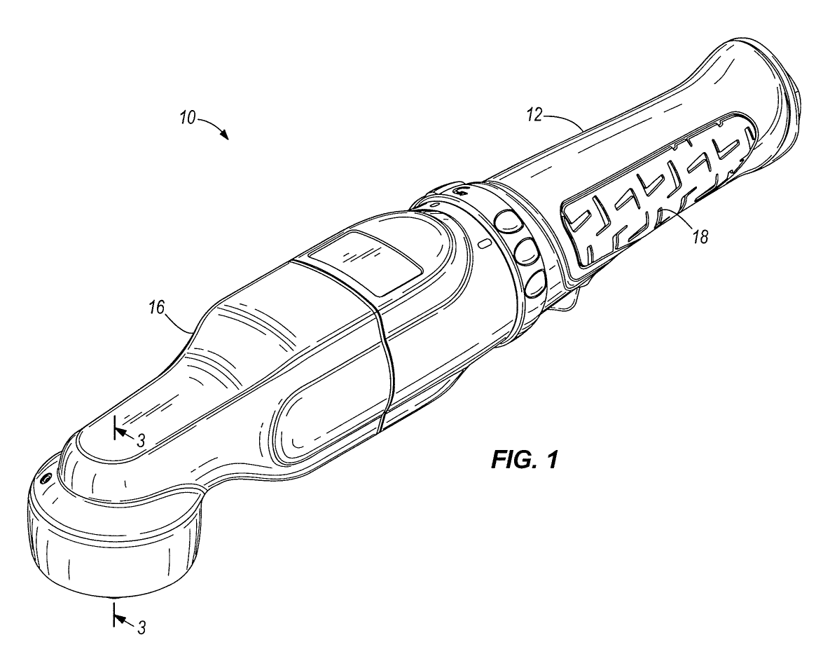

FIG. 1 illustrates a power tool 10 according to an embodiment of the invention. The power tool 10 can be any type of rotary tool, including, for example, a screwdriver, a drill, etc. The power tool 10 includes a motor housing 12, a motor supported within the motor housing 12 (not shown), and an angle head 16 coupled to the motor housing 12. A handle grip 18 is formed on the outside of the motor housing 12.

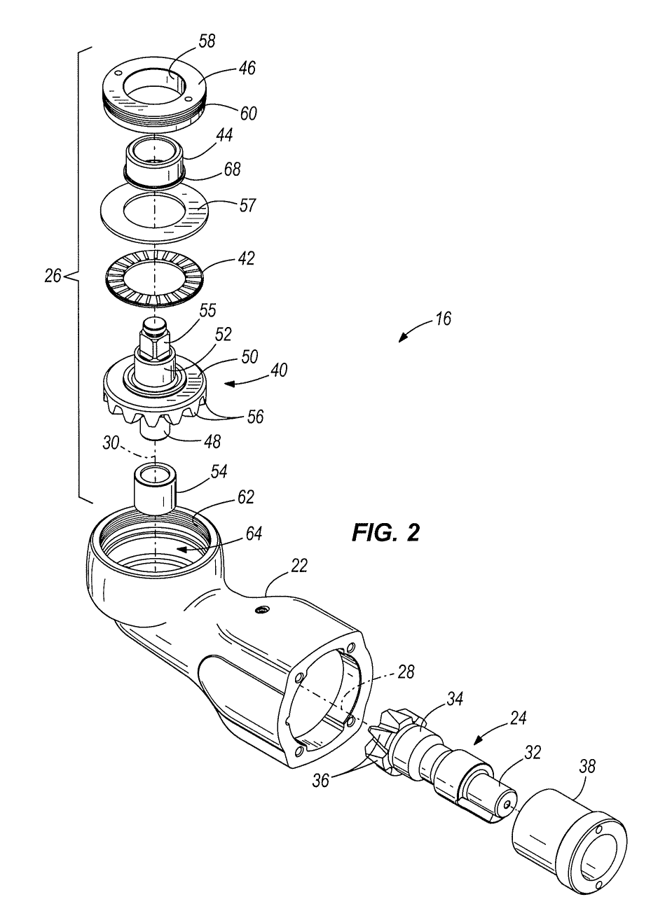

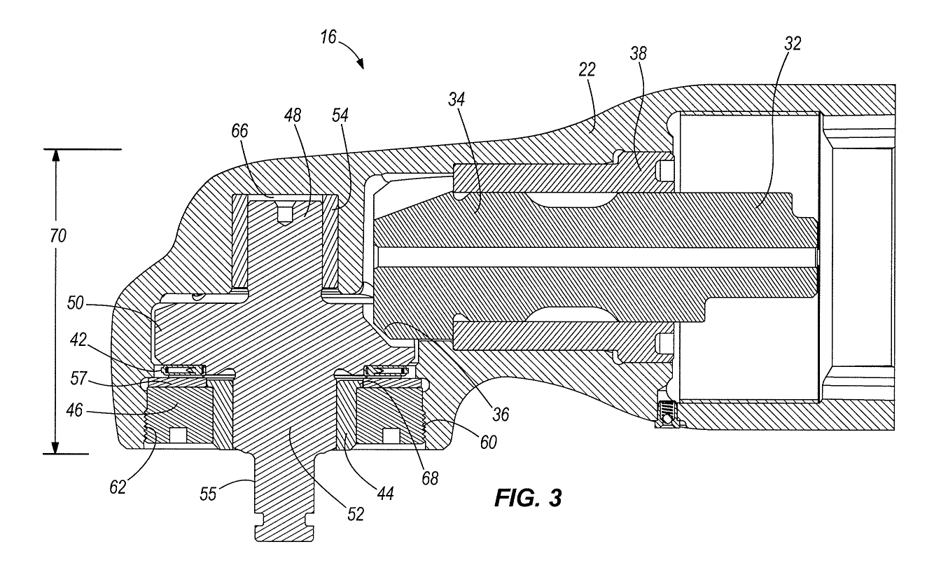

FIGS. 2 and 3 illustrate the angle head 16, which includes an angle housing 22, a pinion shaft 24 and a gear assembly 26. The angle housing 22 defines first and second non-parallel axes 28, 30. In some embodiments, the first axis 28 is perpendicular to the second axis 30. In other embodiments (not shown), the first axis 28 is at an acute or obtuse non-parallel angle to the second axis 30.

The pinion shaft 24 has a first end 32 and a second end 34. The first end 32 is adapted to be coupled to the motor of the power tool 10. The pinion shaft 24 is rotatable under the influence of the motor within the angle housing 22 about the first axis 28. A bearing 38 is provided for supporting the pinion shaft 24 within the angle housing 22 for rotation about the first axis 28. The second end 34 of the pinion shaft 24 has pinion teeth 36 for engaging the gear assembly 26.

The gear assembly 26 includes a bevel gear 40, a thrust bearing 42, an axial bearing 44 and a retaining nut 46. The bevel gear 40 includes an upper shaft 48, a toothed portion 50, and an output spindle 52. The upper shaft 48 is supported for rotation about the second axis 30 with a bushing 54. The toothed portion 50 is located in between the upper shaft 48 and the output spindle 52 and includes bevel teeth 56. The bevel teeth 56 are sized and shaped to meshingly engage with the pinion teeth 36 of the pinion shaft 24. The output spindle 52 can have a standard square drive 55.

The thrust bearing 42 is trapped between the retaining nut 46 and the toothed portion 50 of the bevel gear 40. In some embodiments (not shown), the thrust bearing 42 is integrally formed with the retaining nut 46. The thrust bearing 42 helps to support the bevel gear 40 for rotation about the second axis 30 and resists movement of the bevel gear 40 in a direction parallel to the second axis 30. In some embodiments, the thrust bearing 42 is a needle bearing. The gear assembly 26 can include a flat washer 57 between the retaining nut 46 and the thrust bearing 42.

The axial bearing 44 surrounds the output spindle 52 and is sandwiched between the retaining nut 46 and the output spindle 52. In some embodiments, the axial bearing 44 is press fit to the inside surface 58 of the retaining nut 46. The axial bearing 44 is separate from the thrust bearing 42 and resists movement of the bevel gear 40 in a direction perpendicular to the second axis 30. In some embodiments (not shown), the axial bearing 44 is integrally formed with the retaining nut 46.

The retaining nut 46 has an inner surface 58 and an outer surface 60. The outer surface 60 is threaded for engagement with an inner surface 62 of the angle housing 22 to secure the retaining nut 46 to the angle housing 22. The inner surface 58 surrounds the axial bearing 44 and the output spindle 52.

The gear assembly 26 can be assembled with the angle housing 22 by sequentially dropping the components of the gear assembly 26 through an opening 64 in the angle housing 22. First, the bushing 54 is dropped into a recess 66 in the angle housing 22 (see FIG. 3). Next, the bevel gear 40 is dropped into the angle housing 22 so that the upper shaft 48 is surrounded by the bushing 54. Then, the thrust bearing 42 is fit over the output spindle 52 and is dropped through the opening 64 to bear against the toothed portion 50. Next, the axial bearing 44 is fit over the output spindle 52 and dropped through the opening 64. Then, the retaining nut 46 is fit over the output spindle 52 and is dropped through the opening 64 and is rotated so that the outer surface 60 threadingly engages the inner surface 62 of the angle housing 22. The retaining nut 46 acts against a shoulder 68 of the axial bearing 44. The retaining nut 46 can be tightened onto the angle housing 22 to secure the gear assembly 26 within the angle housing 22. In some embodiments, the axial bearing 44 is press-fit within the retaining nut 46 so that the retaining nut 46 and the axial bearing 44 are dropped into the opening 64 together.

The angle head 16 transmits rotation of the pinion shaft 24 about the fist axis 28 to rotation of the output spindle 52 about the second axis 30. To do this, the pinion teeth 36 of the pinion shaft 24 meshingly engage the bevel teeth 56 of the bevel gear 40. As the pinion shaft 24 rotates about the first axis 28, the pinion teeth 36 drive rotation of the output spindle 52. The thrust bearing 42 and the axial bearing 44 support the bevel gear 40 for rotation. The thrust bearing 42 resists movement of the bevel gear 40 in a direction parallel to the second axis 30, while the axial bearing 44 resists movement of the bevel gear 40 in a direction perpendicular to the second axis 30.

The power tool 10 can be useful in order to position the output spindle 52 of the tool 10 in an orientation that is convenient for the task that is being performed while permitting the operator to grasp and manipulate the power tool 10 with the hand grip 18 in an orientation that is convenient for the operator. A head height dimension 70 of the angle head 16 is illustrated in FIG. 3. The head height dimension 70 is the axial distance from the top of the angle head 16 to the beginning edge of the square drive feature 55 of the output spindle 52. The head height dimension 70 is reduced so that the angle head 16 can fit into small spaces.

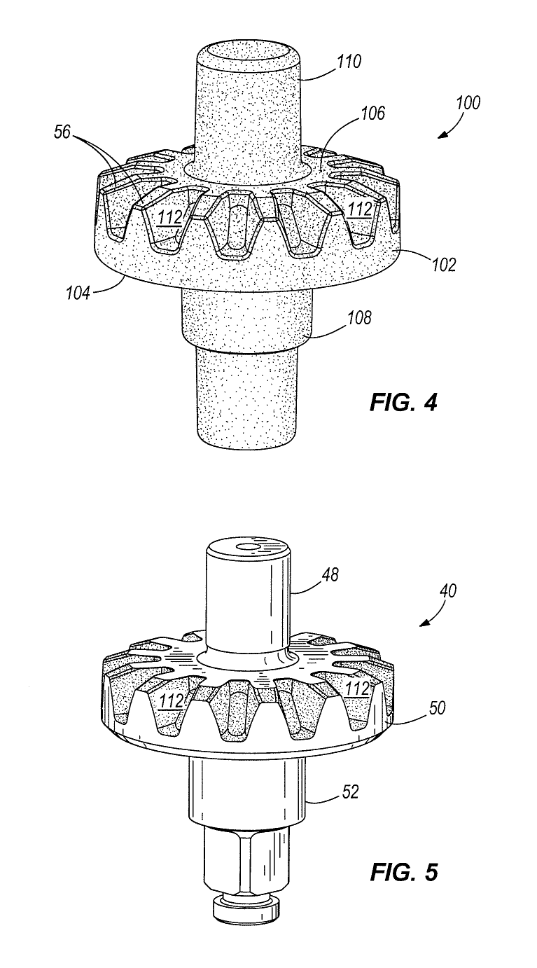

Referring now to FIGS. 4 and 5, the upper shaft 48, toothed portion 50 and output spindle 52 of the bevel gear 40 can be integrally formed with one another such that the bevel gear 40 is a single, monolithic piece. The bevel gear 40 can be formed through a two-step process. In the first step, a bevel gear blank 100 is formed from raw material through a forging process, as illustrated in FIG. 4. The blank 100 includes a toothed portion 102 having first and second sides 104, 106, a first extension 108 extending from the first side 104 of the toothed portion 102, and a second extension 110 extending from the second side 106 of the toothed portion 102. The blank 100 can be formed by precision forging to form precision forged surfaces 112 of bevel teeth 56 of the toothed portion 102 within strict tolerances.

In the second step, the blank 100 of FIG. 4 is machined to transform the blank 100 into the bevel gear 40 as illustrated in FIGS. 2, 3 and 5. Machining can include cutting, polishing and/or grinding processes as are known in the art to remove material from selected portions of the blank 100. The machined portions are indicated in FIG. 5 by the solid surfaces. Various surfaces of the toothed portion 102 are machined to form the toothed portion 50, and the first and second extensions 108, 110 are machined to form the output spindle 52 and upper shaft 48, respectively. The forged surfaces 112 of the bevel teeth 56 are not subject to machining, as indicated by the unchanged mottling in FIGS. 4 and 5.

Thus, the invention provides, among other things, an angle head for use with a power tool. Various features and advantages of the invention are set forth in the following claims.

What is claimed is:

1. An angle head for use with a power tool, the angle head comprising:
an angle housing defining first and second non-parallel axes;
a pinion shaft supported within the angle housing for rotation about the first axis, the pinion shaft having a first end that includes a plurality of pinion teeth, and a second end adapted to be engaged by a motor of a power tool; and
a bevel gear supported in the angle housing for rotation about the second axis and including an upper shaft, a toothed portion, and an output spindle;
wherein the upper shaft, toothed portion, and output spindle are integrally formed as a single, monolithic structure;
wherein the toothed portion is between the upper shaft and output spindle; and
wherein the toothed portion includes a plurality of bevel teeth in meshing engagement with the pinion teeth such that rotation of the pinion shaft about the first axis causes rotation of the bevel gear about the second axis.

2. The angle head of claim 1, further comprising a thrust bearing resisting movement of the bevel gear in a direction parallel to the second axis, and an axial bearing separate from the thrust bearing and resisting movement of the bevel gear in a direction perpendicular to the second axis.

3. The angle head of claim 2, further comprising a retaining nut surrounding the output spindle and the axial bearing, the retaining nut being secured to the angle housing to retain the bevel gear in the angle housing.

4. The angle head of claim 3, wherein the thrust bearing is trapped between the retaining nut and the toothed portion of the bevel gear.

5. The angle head of claim 3, wherein the thrust bearing is integrally formed with the retaining nut.

6. The angle head of claim 1, wherein the thrust bearing is a needle bearing.

7. The angle head of claim 1, wherein the first axis is perpendicular to the second axis.

8. A power tool comprising:
a motor housing;
a motor supported in the motor housing;
an angle housing coupled to the motor housing and defining first and second non-parallel axes;
a pinion shaft supported within the angle housing for rotation about the first axis, the pinion shaft having a first end that includes a plurality of pinion teeth, and a second end adapted to be engaged by the motor; and
a bevel gear supported in the angle housing for rotation about the second axis and including an upper shaft, a toothed portion, and an output spindle;
wherein the upper shaft, toothed portion, and output spindle are integrally formed as a single, monolithic structure;
wherein the toothed portion is between the upper shaft and output spindle; and
wherein the toothed portion includes a plurality of bevel teeth in meshing engagement with the pinion teeth such that rotation of the pinion shaft about the first axis causes rotation of the bevel gear about the second axis.

9. The power tool of claim 8, further comprising a thrust bearing resisting movement of the bevel gear in a direction parallel to the second axis, and an axial bearing separate from the thrust bearing and resisting movement of the bevel gear in a direction perpendicular to the second axis.

10. The power tool of claim 9, further comprising a retaining nut surrounding the output spindle and the axial bearing, the retaining nut being secured to the angle housing to retain the bevel gear in the angle housing.

11. The power tool of claim 10, wherein the thrust bearing is trapped between the retaining nut and the toothed portion of the bevel gear.

12. The power tool of claim 10, wherein the thrust bearing is integrally formed with the retaining nut.

13. The power tool of claim 8, wherein the thrust bearing is a needle bearing.

14. The power tool of claim 8, wherein the first axis is perpendicular to the second axis.

15. A method of producing an angle head for use with a power tool, the method comprising the steps of:
(a) providing an angle housing that defines first and second non-parallel axes;
(b) supporting a pinion shaft in the angle housing for rotation about the first axis, the pinion shaft having a first end that includes a plurality of pinion teeth, and a second end adapted to be engaged by a motor of a power tool;
(c) forging a bevel gear blank having a toothed portion with first and second opposite sides and a plurality of forged bevel teeth, an upper extension extending from the first side, and a lower extension extending from the second side;
(d) machining the upper extension to form an upper support shaft and the lower extension to form an output spindle to turn the bevel gear blank into a bevel gear; and
(e) supporting the bevel gear within the angle housing for rotation about the second axis, with the forged bevel teeth in meshing engagement with the pinion teeth of the pinion shaft such that rotation of the pinion shaft about the first axis causes rotation of the bevel gear about the second axis.

16. The method of claim 15, wherein step (e) includes supporting the bevel gear with a thrust bearing to resist movement of the bevel gear in a direction parallel to the second axis, and supporting the bevel gear with an axial bearing separate from the thrust bearing to resist movement of the bevel gear in a direction perpendicular to the second axis.

17. The method of claim 16, wherein step (e) includes securing a retaining nut to the housing around the output spindle and axial bearing to retain the bevel gear in the angle housing.

18. The method of claim 17, wherein step (e) includes trapping the thrust bearing between the retaining nut and the second side of the toothed portion of the bevel gear.

19. The method of claim 17, further comprising forming the thrust bearing integrally with the retaining nut.
